(19) United States
(12) Patent Application Publication
(10) Pub. No.: US 2018/0298846 A1
(43) Pub. Date: Oct. 18, 2018

(54) Liquid Propellant Chemical Rocket Engine Reactor Thermal Management System

(71) Applicant: ECAPS Aktiebolag, Solna (SE)

(72) Inventors: Kjell Anflo, Haninge (SE); Benjamin Crow, Solna (SE)

(21) Appl. No.: 15/566,362

(22) PCT Filed: Apr. 14, 2016
(86) PCT No.: PCT/SE2016/000017

§ 371 Date: Oct. 13, 2017

(30) Foreign Application Priority Data
Apr. 14, 2015 (EP) 15163530.7

(51) Int. Cl. F02K 9/68; F02K 9/42; F02K 9/52; B64G 1/40; F02K 9/58

(52) U.S. Cl. CPC F02K 9/68; F02K 9/425; F05D 2260/20; B64G 1/401; F02K 9/58; F02K 9/52

(57) ABSTRACT

The present invention relates to a liquid propellant chemical rocket engine reactor Thermal Management System (TMS), which system comprises a reactor comprising a thermally conductive reactor housing, a heat bed, and a catalyst bed, which system further comprises an injector configured to spray the propellant in the form of a cone towards a portion of the circumference of the inner surface of the reactor housing, and an electrical heater located on the outside or inside of the reactor housing for heating said portion of the inner surface of the reactor housing. The invention also relates to a rocket engine comprising the reactor Thermal Management System, a spacecraft comprising the engine, as well as to a method of decomposing a liquid propellant, which can be carried out using the inventive reactor Thermal Management System, wherein vaporization of the propellant is accomplished by bringing the propellant into close proximity to, or to imping on, a portion of the circumference of said inner reactor surface adjacent to the injector.

### FIELD OF THE INVENTION

The present invention relates to a liquid propellant chemical rocket engine reactor Thermal Management System (TMS), which system comprises a reactor comprising a thermally conductive reactor housing, a heat bed, and a catalyst bed, which system further comprises an injector configured to spray the propellant in the form of a cone towards a portion of the circumference of the inner surface of the reactor housing, and an electrical heater located on the outside or inside of the reactor housing for heating said portion of the inner surface of the reactor housing. The invention also relates to a rocket engine comprising the reactor Thermal Management System, a spacecraft comprising the engine, as well as to a method of decomposing a liquid propellant, which can be carried out using the inventive reactor Thermal Management System, wherein vaporization of the propellant is accomplished by bringing the propellant into close proximity to, or to imping on, a portion of the circumference of said inner reactor surface adjacent to the injector.

### BACKGROUND ART

Liquid Propellant Chemical Rocket Engines (LPCREs), also referred to as thrusters, are used e.g. in aerospace applications for 1) orbit raising, orbit maneuvers and maintenance, attitude control and deorbiting of spacecraft, and/or 2) propellant settling, attitude, roll control and divert maneuvers of missiles, launchers, space planes, spacecraft and satellites. Examples of LPCREs have been disclosed in e.g. WO 02/095207, WO 2013/169192, WO 2013/169193, and WO 2014/189451. In such thrusters, which comprise a catalyst, pressure spiking, especially during the start transient (i.e. hard starts), is a phenomena that has been frequently observed. Pressure spiking is due to the temporary accumulation of liquid propellant and decomposition thereof at a very high rate, causing a rapid pressure increase (spike) in the combustion chamber. The reactor temperature is a significant factor to this phenomenon for several mechanisms, including: catalyst wetting with liquid propellant, impingement of liquid propellant on hot surfaces, and different thermal expansion effects. If the reactor temperature is above a certain threshold the liquid vaporization and decomposition is rapid enough to prevent an accumulation of the propellant in liquid state. However, if the reactor temperature is below a critical temperature, heat cannot be transferred to the incoming propellant sufficiently rapidly to avoid the accumulation of liquid propellant in the reactor, thus causing a pressure spike when the delayed ignition occurs.

The thruster's on-time, duty cycle and pulse train duration are key operational factors which have a significant impact on the reactor bed thermal dynamics. The incoming propellant will initially cool the upstream part of the reactor, until it is heated up again by the heat flow from the downstream part of the reactor where the combustion takes place. For specific pulse trains, such cooling can temporarily bring the reactor below the critical temperature at which spiking occurs. The lowest reactor temperature, and thereby where the most severe spiking occurs arises after sufficient mass of propellant has been injected within a certain time span, almost regardless of the duty factor. For example, in the case of a 22 N HPGP® thruster of prior art design, the present inventors found that the lowest reactor temperature was reached after approximately 5 grams of LMP-103S propellant within 15 seconds had been injected in to the reactor, regardless of propellant feed pressure or pulse mode.

Pressure spiking can significantly decrease the thruster performance and life. Severe spiking causes pressure and temperature transients which subject the catalyst to high impact loads, pressure crushing, abrasion and attrition. These effects result in catalyst fracture and break down into fines at a rate dependent on magnitude and number of spikes. Catalyst breakup can lead to another degradation mechanism, viz. catalyst bed compaction, whereby the resulting fine catalyst particles collect in the bed or against screens and plates and increase the propellant mass flow resistance. The result is a reduced propellant flow rate, lower thrust and pulsing impulse bits. There is also some reduction in specific impulse mainly due to the mass flow rate reduction. Severe spiking has also resulted in the rupture of the chamber, and has caused the thruster propellant valve to leak.

Even mature monopropellant thruster designs with extensive flight heritage may be greatly affected by a change in duty cycle and a design shown to be superior in one application may not be optimum with changed operational modes. Therefore, it may not be possible with prior art thrusters to select a single design that would perform satisfactorily for all duty cycles.

### SUMMARY OF THE INVENTION

The present inventors have found that the way the propellant is injected into the reactor and being heated, can significantly suppress undesirable cooling of the reactor, thus improving performance and the life of the thruster. Accordingly, the present invention enables a design for a given thrust level that would perform satisfactorily for all pulse mode duty cycles.

According to the invention, the propellant is, by means of the injector, sprayed into the reactor against a heated portion of the inner surface of the reactor housing adjacent to the injector with the aim to achieve vaporization near or at the reactor wall. This principle is unlike the prior art monopropellant thrusters where the design strives to inject the propellant and to evenly distribute the propellant over the heat bed, and thus over the whole cross section of the reactor, with the purpose to achieve an even bed load in the heat bed.

Accordingly, in a first aspect the present invention relates to a reactor Thermal Management System (TMS) for a liquid propellant chemical rocket engine 10, which system comprises: a reactor for vaporizing a liquid monopropellant and initiating decomposition thereof, said reactor comprising a thermally conductive reactor housing 200, a catalyst bed 160B, and a heat bed 160A which is in indirect thermal contact with the catalyst bed via the reactor housing; an electrical heater 170; and, an injector 151, wherein the heat bed 160A is located upstream of the catalyst bed and downstream of the injector and wherein the injector exhibits one or more openings 155 for the propellant directed laterally towards a portion 159 of the circumference of the inner surface of the reactor housing for injecting the propellant in the form of a cone against said portion, and in the heater 170 being being attached to and in thermal contact with said portion, which portion is located upstream of the catalyst bed.

The injector of the inventive reactor TMS is configured to spray the propellant in the form of a cone towards a portion 159 of the inner surface of the reactor housing adjacent to the injector. Thereby the propellant can be used effectively for cooling an injector face 150. At the same time an even distribution of propellant along the inner circumference of the combustion chamber can be accomplished. Preferably, the cone half-angle of the cone is within the range of 35°-55°.

In preferred embodiments the reactor Thermal Management System further comprises a heat reservoir 180 adjacent to the heater 170, which reservoir is in thermal contact with the reactor housing and heater. The heat reservoir serves to accumulate heat from the electrical heater during pre-heating, and, during operation of the engine, to receive heat from the downstream combustion transferred via the housing, and to convey thus accumulated heat to the portion 159 of the inner surface of the reactor housing, towards which portion the propellant is being injected during operation of the engine.

The heat reservoir 180 can be made integral with the reactor housing 200, or can be attached to the outside, or to the inside of the reactor housing.

The reactor TMS preferably comprises a flow restrictor 100, preferably in the form of a cavitating venturi, on a propellant feed pipe 140 upstream of the injector and upstream of a propellant flow control valve 110. The flow restrictor serves to suppress the propellant flow surge which otherwise typically will occur at the beginning of each pulse fired.

In a further aspect the invention relates to a liquid propellant rocket engine comprising the above thermal management system.

In yet a further aspect the invention relates to a spacecraft, satellite or space place comprising one or more engines of the invention.

In a further aspect the invention relates to a process of decomposing a liquid propellant in a liquid propellant chemical rocket engine comprising a reactor housing 200, which method comprises the steps of: A subjecting the propellant to a temperature efficient for essentially bringing the propellant into the vapour phase; B bringing the essentially vaporised propellant into contact with a catalyst and decomposing the propellant into hot, gaseous combustible components; C combusting the combustible components obtained in step B; and, D transferring heat generated in step B and/or in step C to step A, wherein the vaporization in step A is accomplished by injecting the propellant towards a heated portion 159 of the inner surface of the reactor housing of the engine, which portion is in thermal contact with an electrical heater 170 attached to the reactor housing, which heater is configured to heat said portion by direct transfer of heat from said heater, and/or from a heat reservoir 180 heated by said heater.

In a preferred embodiment of the inventive process, in step D, heat is transferred to a heat reservoir 180, which reservoir is in thermal contact with the heater and with said portion of the inner reactor surface towards which portion the propellant is being injected in step A. The use of a heat reservoir allows for improved persistence to cooling by propellant during start of the thruster.

A major advantage of the invention is that existing and well proven catalysts for the subject monopropellant(s) can be used with a high performance, low-hazard and environmental benign propellants, such as LMP-103S or similar.

According to the invention, the propellant impinging on the reactor wall is also providing film cooling of the subject wall, thus choking/quenching the flow of heat to the injector from the combustion occurring downstream in the reactor.

The invention is applicable for liquid propellant chemical rocket engines with thrust levels larger than 1 N.

The present invention enables a design for a given thrust level and blow down ratio that would perform satisfactorily for all pulse mode duty cycles. E.g. a 22 N HPGP® thruster using the LMP-103S monopropellant was designed according to the present invention. Hot firing tests of the subject thruster demonstrated that hard starts were eliminated for all pulse mode firing duty cycles and there were no operational limitations, whereas an earlier thruster version which was designed according to prior art had significant hard start issues and pulse mode firing limitations with respect to injector head overheating.

In addition, a 22 N HPGP® thruster designed according to the present invention also demonstrated significantly improved pulse mode specific impulse, faster response times and the ability to fire nominal pulses at lower preheating temperature, thus reducing preheating power and duration.

As an example, according to the invention the pulse mode specific impulse was up to 5% higher than for the prior art thruster at same T_{ON}, duty, and pressure.

As a further example, according to the invention the response times; i.e. the thrust rise time, and decay time, were reduced with approximately 50%.

Moreover, according to the invention the required preheating temperature could be lowered by approximately 50-100° C. corresponding to 10 to 25% lower preheating power. The peak and average preheating power can be a critical factor for spacecraft electrical power budget.

Further, aspects, advantages and embodiments will be apparent from the following detailed description and appended claims.

The present invention is primarily intended for use with ADN- or HAN-based liquid propellants, especially liquid ADN-based propellants.

As used herein the term “direct transfer of heat” is intended to refer to heating of the portion of the inner reactor surface directly by the heater, or by a heat reservoir of the invention. The term implies that the heater, and, if present, also the heat reservoar, are located adjacent to the portion to be heated. The distance from the heater and, if present, the heat reservoar, to the portion to be heated should preferably be kept to a minimum. The inventive heating accordingly is in contrast to prior art heating as disclosed e.g. in U.S. Pat. No. 4,583,361.

The inventive engine will typically have improved performance as compared to a corresponding prior art liquid propellant chemical rocket engine, and substantially improved life time and pulse mode performance.

### BRIEF DESCRIPTION OF THE ATTACHED DRAWINGS

FIG. 1 illustrates the difference in thrust envelope characteristics between a thruster designed according to prior art which exhibits hard starts vs a thruster designed according to the invention where the hard starts are eliminated.

FIG. 2 illustrates the thruster operational area, i.e. Duty vs T_{ON}, and the hard starts area (shaded) for a 22 N HPGP® prior art thruster. With a corresponding thruster of the present invention the hard starts area is eliminated.

FIG. 3 illustrates a monopropellant thruster 10 according to the invention comprising an injector 151 a heat reservoir 180.

FIG. 4 shows the injector 151 according to invention, and propellant injection pattern into the upstream part of a reactor according to one embodiment of the injector of the invention, wherein reference numeral 157 represents propellant being injected into the reactor from injector openings 155. Reference numeral 159 represents vaporization of the propellant and also represents the portion of the inner surface of the reactor housing towards which portion the propellant is being injected.

FIG. 5 is an enlarged partial view of the encircled area denoted “Def. A” in FIG. 3 comprising electrical heater 170, heat reservoir 180, and heat shield 190. In FIG. 5 the portion of the inner surface of the reactor housing against which portion the propellant is injected is indicated by a bracket spanning over said portion in the longitudinal direction of the engine.

FIG. 6 is an enlarged view of the encircled area denoted “Def. B” in FIG. 3 comprising a restrictor 100 in the form of a cavitating venturi restrictor.

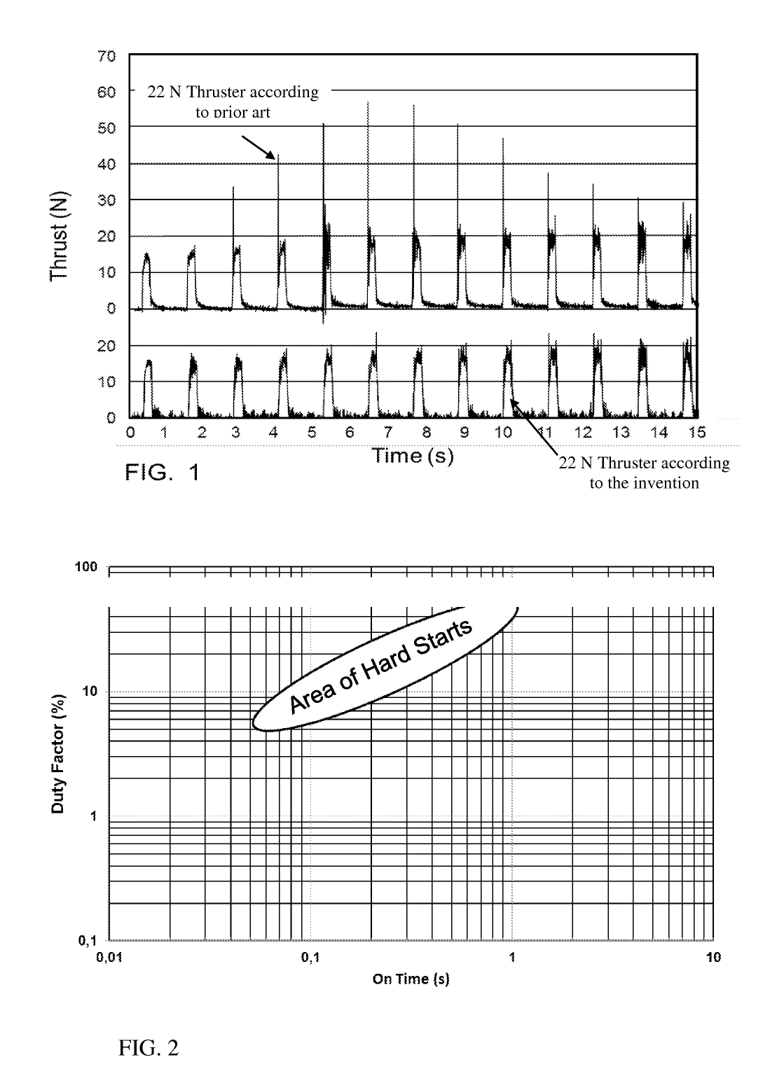

### DETAILED DESCRIPTION OF THE INVENTION AND PREFERRED EMBODIMENTS THEREOF

According to the present invention preheating is accomplished by means of an electrical heater attached to the reactor housing. Thereby direct transfer of heat to a restricted portion of the reactor can be accomplished. Preheating can thus be made very efficient and responsive. The location of the heater is made possible by means of cooling by the propellant being injected towards the portion of the housing inside the reactor, to which portion the heater is in thermal contact, thereby accomplishing cooling of the heater during operation of the reactor. In the absence of cooling the heater would be damaged by heat generated from combustion downstream in the reactor being conveyed to the heater during operation of the thruster. In order to improve the heat capacity of the heated portion a heat reservoir may be included as will be explained in more detail below.

The present invention utilizes the heat capacity of the reactor housing. The reactor housing has a higher heat capacity as compared to the heat bed of the reactor. Additionally, the reactor housing also has access to heat accumulated in the heat bed. When combustion has been initiated heat from the downstream combustion will be transferred in the reactor housing up to the portion of the housing against which portion propellant is being injected. Transfer of heat upstream via the reactor housing is much quicker than transfer of heat via the heat bed. Accordingly, reheating of the portion of the reactor housing where vaporization of the propellant is accomplished in an inventive engine will be much quicker than reheating of the heat bed in comparable prior art engine. This is especially important in pulse mode operation. A heat reservoar may be provided to initially improve, during ignition of the engine, the heat transfer to the portion of the housing against which portion propellant is being injected. During operation of the engine the reservoar will accumulate heat from the downstream combustion being conveyed upstream through the reactor housing.

The present invention utilizes an improved distribution of propellant over a preheated surface, which surface moreover can be heated and preheated quicker than the preheated surface in prior art engines. During start of a prior art engine relying on a preheated heat bed, a given point in the heat bed will receive heat from surrounding catalyst particles and from the reactor housing. During operation heat will be radiated back into the bed from the downstream combustion to reheat the heat bed.

According to the invention, the propellant is, by means of the injector 151, sprayed into the reactor against a heated portion of the inner surface of the reactor housing thereby achieving vaporization 159 of the propellant 157 near or at the reactor wall, as shown in FIG. 4.

In a preferred embodiment of the invention the propellant feed channels 154 within the injector 151 shall have a minimum volume to minimize the dribble volume. A small dribble volume is beneficial for the thruster response time.

In a preferred embodiment of the invention the propellant feed channels within the injector shall be distributed so that the injector face 150 is sufficiently cooled. An example of such embodiment of the inventive injector 151 is shown in FIG. 4.

With reference to FIG. 4, injector 151, and the propellant injection into the reactor are illustrated. Propellant 157 enters the injector head at 153, and is distributed within the injector face 150. The propellant 157 is by means of the injector openings 155 (the figure shows individual circular holes) sprayed into the reactor evenly distributing the propellant towards the circumference of the reactor wall, thereby achieving vaporization 159 near or at the reactor wall 200.

According to the invention the propellant impingement on the reactor wall is also providing film cooling of the subject wall, thus choking/quenching the heat flux to the injector 151 from the combustion occurring downstream in the reactor, and furthermore initially cools the reaction chamber downstream of the impingement.

While in principle one slit running along the injector could be used as opening 155, such embodiment is less preferred, since the direction of injection will be harder to control accurately. A number of individual openings distributed around the injector is generally preferred according to the invention, since controlled and reliable direction of injection thus easily can be accomplished. The openings are preferably provided as circular holes or slits.

For larger engines, such as above 50 N, which will have a wider inner cross-section, in order to take advantage of the heat capacity of the heat bed it is preferred that the injector additionally is provided with openings directed in parallel with the longitudinal axis of the engine, i.e. directed towards the heat bed. In embodiments with openings in the injector directed in to the heat bed it is preferred that a large majority, e.g. about 90%, of the propellant being injected is injected towards the reactor housing.

For engines up to 22 N it is preferred that the propellant is injected in the form of a hollow cone and that all propellant be injected in a direction towards the heated portion of the inner surface of the reactor housing.

Thrusters 10 of the invention may advantageously be operated on reduced risk liquid storable propellants, such as Ammonium DiNitramide (ADN) based liquid monopropellants, and bipropellants, e.g. High Performance Green Propulsion (HPGP) monopropellants, and bipropellants, or on hydroxyl ammonium nitrate (HAN) based liquid monopropellants, and bipropellants. Thrusters, and the functional elements thereof, such as the injector and reactor for such propellants, except for the inventive injector and heat reservoir described herein, have been described in e.g. WO 02/095207, WO 2013/169192, WO 2013/169193, and WO 2014/189451.

The present invention thus relates to mono-, bipropellant, and dual mode chemical rocket engines 10 comprising catalyst(s) for use in such engines and the inventive reactor Thermal Management System including the inventive injector 151.

The heat bed of the inventive reactor TMS may preferably exhibit catalytic activity, such as e.g. disclosed in WO 2013/169193.

The inventive reactor Thermal Management System preferably also comprises a heat reservoir 180. The heat reservoir 180 is located adjacent to the portion of the reactor wall 200 at the location where the propellant boils or spray from the injector head impinges on the reactor compartment wall. The purpose of the heat reservoir is to accumulate heat during the preheating. The heat required to instantly bring the injected propellant to vaporize, decompose and ignite is much higher than the electrical heater can provide. Therefore, a part of the reactor needs to be preheated to provide the necessary heat capacity for initiating vaporization, decomposition and ignition of the propellant. In the present invention an upstream portion of the reactor housing is preheated to provide the necessary heat. The heat reservoir and the corresponding inner reactor surface have to be preheated by an electrical heater 170 prior to firing. When the injected propellant begins to cool the reactor compartment wall, heat from the heat reservoir flows into the reactor compartment via its wall 200 and suppresses the cooling thereof. When the combustion downstream in the catalyst bed 160B generates enough heat, the back flow of heat begins to recharge the heat reservoir 180. During firing, heat from the propellant combustion generated downstream in the combustion chamber is thus transferred back to the reservoir 180 via the reactor wall 200.

The heat reservoir can be made integral with the reactor housing, in which case the reservoir is made of same material as conventionally used for the reactor housing, preferably same material as used in the HPGP® engine technology. When made integral with the reactor housing, the thickness of the reactor wall will be increased in the heat reservoir section.

In embodiments wherein the heat reservoir 180 is attached to the outside of the reactor housing, the reservoir is located in thermal contact with both heater and reactor housing, on the outside of the portion 159 where the propellant impinges on the inner reactor wall. The heat reservoir shall have high specific heat capacity and high thermal conductivity. When attached to the outside of the reactor housing the heat reservoir 180 should be made in a suitable material with respect to heat capacity, heat conduction, and thermal expansion coefficient. The material of the heat reservoir should accordingly exhibit same or similar thermal expansion coefficient as that of the material of the reactor housing. A suitable material for the heat reservoir is e.g. copper. If attached to the inside of the reactor a suitable refractory lining will be required to protect the heat reservoir.

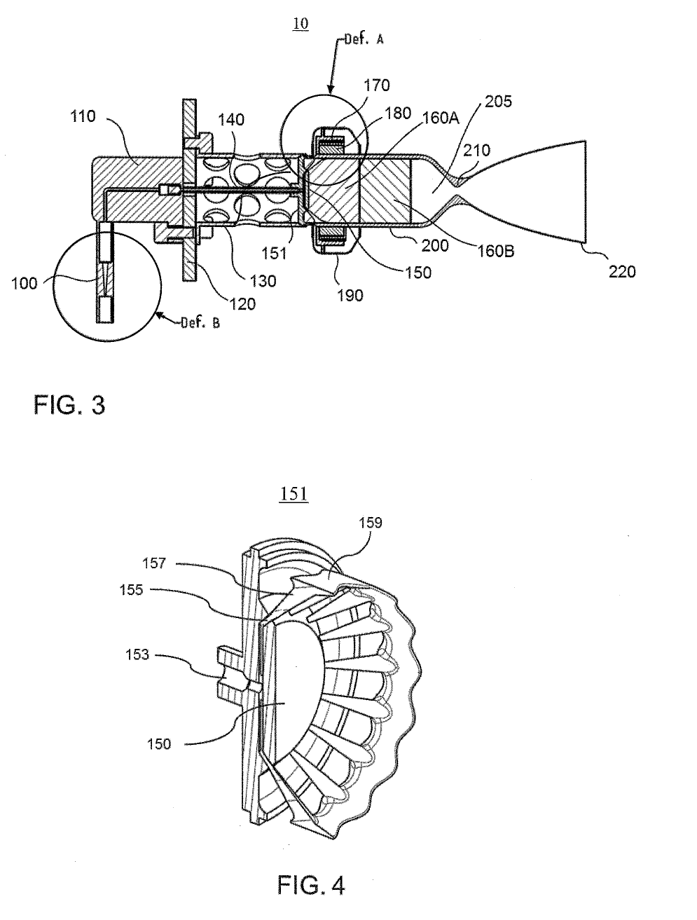

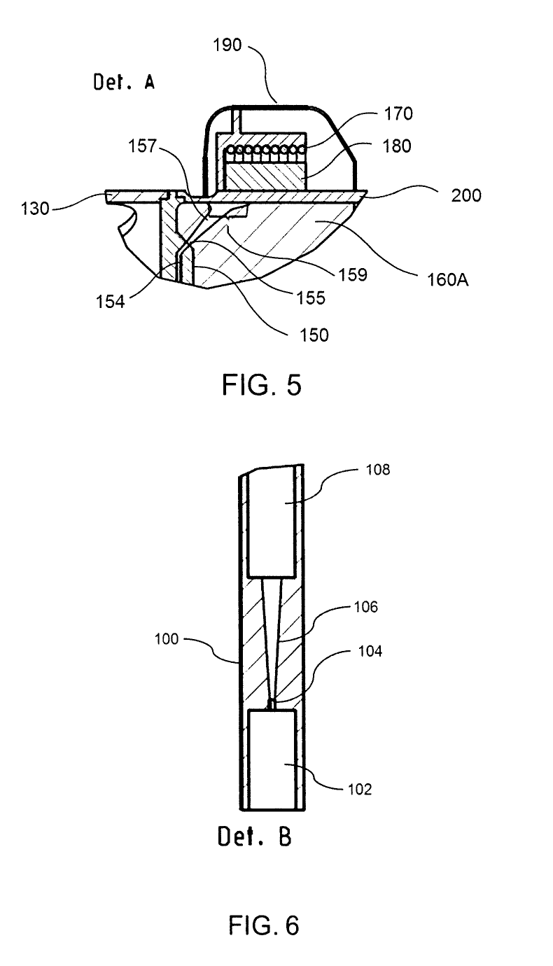

The electrical heater preferably uses a coil of a resistive heating cable running along the periphery of the combustion chamber as shown in FIGS. 3 and 5.

In a preferred embodiment of the invention a flow restrictor 100, e.g. a cavitating venturi, is implemented into the propellant flow path in the thruster upstream of the injector in order to suppress the propellant flow surge which otherwise will occur at the beginning of each pulse fired and before the combustion chamber pressure is built up, which leads to excessive cooling of the reactor as previously explained. The flow restrictor can lower the surge flow rate at the maximum operational feed pressure with up to a fourth as compared the prior art thrusters. The flow restrictor does not change the thermal time constants in the thruster, but lowers the cooling effect of the upstream part of the reactor, and also lowers the generated heat in the downstream part of the reactor.

FIG. 6 is an enlarged view of the propellant flow restrictor 100 in the encircled area denoted “Def. B” in FIG. 3. The propellant enters the flow restrictor at 102. Cavitating venturi is known in the art and has been disclosed e.g. in U.S. Pat. No. 5,647,201, and will not be described in closer detail herein. Briefly, converging section 104 will restrict the mass flow of propellant entering the venturi at the inlet 102. As local velocity increases, the static pressure decreases to a level below the vapour pressure or flash point of the fluid, causing the fluid to vaporize or cavitate. As the vapour bubbles enter the diverging diffuser section 106, the velocity decreases and the static pressure increases above the vapour pressure. This causes vapour or gaseous bubbles to condense to a liquid and the fluid exits the outlet 108. The propellant then enters into the flow control valve 110 shown in FIG. 3 via outlet 108.

In a preferred embodiment of the invention a heat shield/radiator 190 is included. The heat shield/radiator has two functions; 1.) During preheating the heat shield conserves energy by limiting the dissipation of heat radiated from the thruster; 2.) During firing and after the heat reservoir has been recharged the heat shield/radiator radiates excessive heat.

In FIG. 3 a preferred rocket engine design according to the invention is illustrated which comprises an inlet flow control restrictor 100, a normally closed propellant flow control valve (FCV) 110, which by electrical command opens and enables the propellant to flow into the thruster, a thruster mounting bracket 120, a thermal stand-off 130 to isolate the FCV and mounting bracket from heat from the thrust chamber 205, a propellant transfer assembly 140 (i.e. feed tube), which establishes a desiderable propellant pressure drop between the FCV and thrust chamber 205, an injector 151 to distribute the propellant into the reactor, thermal and catalytic bed(s) 160A and 160B which decomposes, ignites and combusts the propellant, an electrical heater 170 which preheats the reactor prior to firing, a heat reservoir 180 as described above, a heat shield/radiator 190, and a combustion chamber 205. The combusted exhaust gases are accelerated through the nozzle 210, 220 thus generating thrust. The electrical heater uses a resistive heating cable, which cable preferably runs around the reactor housing. In a preferred embodiment the cable is provided in the form of a coil extending around the reactor housing. While the heater could be provided on the inside of the reactor housing (not shown), for practical reasons and for simplicity of construction it is preferred that the heater be provided on the outside of the reactor housing, such as e.g. shown in the attached drawings.

### EXAMPLE

A 22 N HPGP® thruster using the LMP-103S monopropellant was designed according to the present invention. Hot firing tests of the thruster demonstrated that hard starts were eliminated for all pulse mode firing duty cycles, and no firing mode limitations were encountered.

The thruster also demonstrated significantly improved pulse mode specific impulse, faster response times and the ability to fire nominal pulses at lower preheating temperature, thus reducing preheating power and duration.

The pulse mode specific impulse was up to 5% higher as compared to that of an prior art thruster at same T_{ON}, duty, and pressure.

The response times, i.e. the thrust rise time, and decay time, were reduced with approximately 50%.

The thruster design allowed for lowering of the required preheating temperature of the reactor from approximately 400° C. to 300° C., corresponding to 25% lower preheating power.

1. A reactor Thermal Management System (TMS) for a liquid propellant chemical rocket engine, which system comprises:
a reactor for vaporizing a liquid monopropellant and initiating de-composition thereof, said reactor comprising a thermally conductive reactor housing, a catalyst bed, and a heat bed, which is in indirect thermal contact with the catalyst bed via the reactor housing;
an electrical heater; and
an injector, wherein the heat bed is located upstream of the catalyst bed and downstream of the injector and wherein the injector exhibits one or more openings for the propellant directed laterally towards a portion of the circumference of the inner surface of the reactor housing for injecting the propellant in the form of a cone against said portion, and in the heater being attached to the reactor housing and in thermal contact with said portion, which portion is located upstream of the catalyst bed.

2. The reactor TMS of claim 1, wherein the cone half-angle of the cone is within the range of 35-55°.

3. The reactor TMS of claim 1, additionally comprising a heat reservoir adjacent to the heater and being in thermal contact with the reactor housing and heater.

4. The reactor TMS of claim 3, wherein the heat reservoir is made integral with the reactor housing.

5. The reactor TMS of claim 3, wherein the heat reservoir is attached to the outside of the reactor housing.

6. The reactor TMS of claim 3, wherein the heat reservoir is attached to the inside of the reactor housing.

7. The reactor TMS of claim 1, wherein the injector also exhibits openings for the propellant directed towards the heat bed.

8. The reactor TMS of claim 1, comprising a flow restrictor on a propellant feed pipe upstream of the injector and upstream of a propellant flow control valve.

9. A Liquid Propellant Chemical Rocket Engine (LPCRE), comprising the reactor Thermal Management System of claim 1, a combustion chamber, and a nozzle.

10. A spacecraft, satellite, or spaceplane including an engine of claim 9.

11. A process of decomposing a liquid propellant in a liquid propellant chemical rocket engine comprising a reactor housing comprising:
A subjecting the propellant to a temperature efficient for essentially bringing the propellant into the vapour phase by injecting the propellant towards a heated portion of the inner surface of the reactor housing of the engine, which heated portion is in thermal contact with an electrical heater attached to the reactor housing, which heater is configured to heat said portion;
B bringing the essentially vaporised propellant into contact with a catalyst and decomposing the propellant into hot, gaseous combustible components;
C combusting the combustible components; and
D transferring heat generated by decomposing the propellant and combusting the combustible components to the propellant.

12. The process of claim 11, wherein, in step D, heat generated in step B and/or in step C is transferred to a heat reservoir, which heat reservoir is in thermal contact with the heater and with said portion of the inner reactor surface towards which portion the propellant is being injected in step A.

13. The process of claim 11, wherein the rocket engine comprises a reactor Thermal Management System (TMS), the TMS comprising:
a reactor for vaporizing a liquid monopropellant and initiating de-composition thereof, said reactor comprising the thermally conductive reactor housing, a catalyst bed, and a heat bed, which is in indirect thermal contact with the catalyst bed via the reactor housing;
the electrical heater; and,
an injector, wherein the heat bed is located upstream of the catalyst bed and downstream of the injector and wherein the injector exhibits one or more openings for the propellant directed laterally towards a portion of the circumference of the inner surface of the reactor housing for injecting the propellant in the form of a cone against said portion, and in the heater being attached to and in thermal contact with said portion, which portion is located upstream of the catalyst bed.

14. The process of claim 12, wherein the heater is configured to heat said portion by direct transfer of heat from said heater.

15. The process of claim 12, wherein the heater is configured to heat said portion by transfer of heat from a heat reservoir heated by said heater

16. The reactor TMS of claim 8, wherein the flow restrictor comprises a cavitating venturi.
